(19) United States
(12) Patent Application Publication
(10) Pub. No.: US 2008/0314420 A1
(43) Pub. Date: Dec. 25, 2008

(54) CLEANING SYSTEM FOR A HOPPER

(75) Inventor: Rick R. Riley, Des Moines, IA (US)

Correspondence Address: ZARLEY LAW FIRM P.L.C., CAPITAL SQUARE, 400 LOCUST, SUITE 200, DES MOINES, IA, 50309-2350, US

(73) Assignee: RT DESIGN, LLC, Altoona, IA (US)

(21) Appl. No.: 11/767,219

(22) Filed: Jun. 22, 2007

(51) Int. Cl. B08B 3/04

(52) U.S. Cl. 134/45

(57) ABSTRACT

A cleaning system for a hopper used to transport and convey salt and sand. The cleaning system includes a fluid supply system that creates a first fluid flow path that takes water from the inlet end of the fluid supply system to an interior chamber of the hopper. A second fluid flow path is created between the inlet end of the fluid supply system to a conveyor system of the hopper. Thus, two fluid flow paths are created to simultaneously clean the interior chamber of a hopper and a conveyor system of the hopper using a single water source.

### BACKGROUND OF THE INVENTION

This invention relates to a cleaning system. More specifically, this invention relates to a cleaning system for a hopper for a salt and or sand spreader truck.

Salt and sand trucks contain hoppers that use a conveyor to deliver sand and or salt or brine solution. Specifically, for example, during inclement weather when ice is on a roadway a spreader truck having a hopper full of salt and sand will drive across the roadway and use a conveyor system to convey the salt and or sand onto the roadways to help melt the ice or provide better grip for drivers. The typical life span of the hoppers is usually greatly decreased as compared to a typical hopper that does not transport sand and or salt. Specifically, salt have a tendency to corrode the hopper and additionally to corrode the conveyor mechanism, both of which are made of metal. As a consequence, hoppers that are of great expense must be replaced often.

One way of preventing corrosion and lengthening the life span of a hopper is by cleaning out the hopper and conveyor system after use. Typically, an individual can take a pressurized hose and spray down the interior and exterior of the hopper and additionally the conveyor system. While successful at cleaning the hopper of salt and sand this process is extremely time consuming. Additionally depending on the thoroughness of the individual cleaning the hopper this method can be ineffective. Another problem associated with the cleaning is that an individual also has to position themselves to clean out the interior of a hopper which in some cases may be dangerous.

Thus, a principal object of the present invention is to provide a cleaning system for a hopper that minimizes the amount of time taken to clean the hopper.

Yet another object of the present invention is to provide a hopper cleaning system that is easy to use.

Another objection of the present invention is to provide a cleaning system that ensures both the interior of a hopper and a conveyor system on the hopper are properly washed.

These and other objects, features or advantages of the present invention will become apparent from the specification and claims.

### BRIEF SUMMARY OF THE INVENTION

A cleaning system for a hopper. The hopper has a housing formed by end walls and side walls to form a hollow interior. Positioned at the bottom of the hopper is a conveyor system comprising drives wheels that engage chains to axially convey a track to transport salt, sand or the like. A fluid supply system having an inlet and a plurality of pipes is secured to the housing and extends along the exterior of the housing. The fluid supply system has an outlet disposed through a port within the housing such that a first fluid flow path for water is created between the inlet of the fluid supply system and the interior of the housing. The fluid supply system additionally has a conveyor supply pipe that has at least one nozzle that is adjacent a drive wheel of the conveyor system to provide a second fluid flow path of water from the inlet of the fluid supply system to the conveyor system.

### BRIEF DESCRIPTION OF THE DRAWINGS

FIG. 1 is a perspective view of a cleaning system for a hopper;

FIG. 2 is a perspective view a fluid supply system.

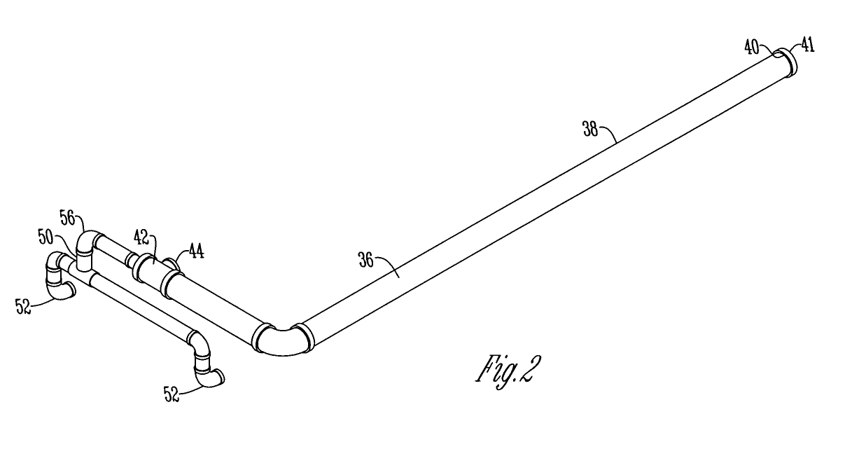

FIG. 3 is a side plan view of a conveyor system of a hopper;

FIG. 4 is a top plan view of a cleaning system for a hopper.

FIG. 5 is a sectional view of a fluid supply system taken along line 5-5 in FIG. 3.

### DETAILED DESCRIPTION OF THE PREFERRED EMBODIMENT

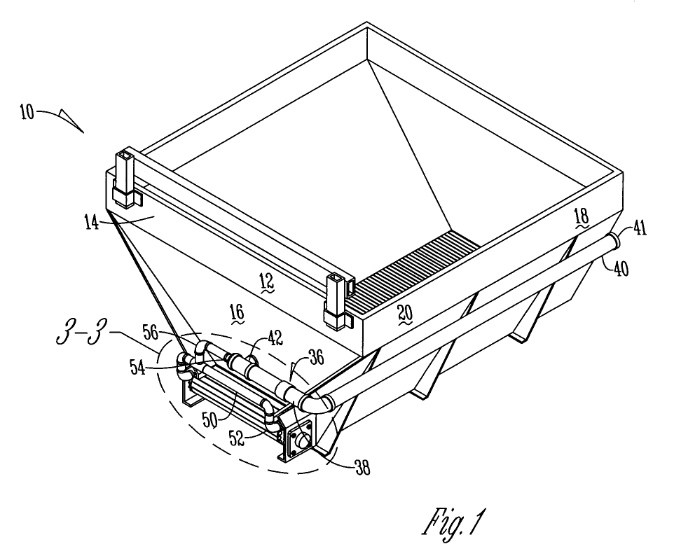

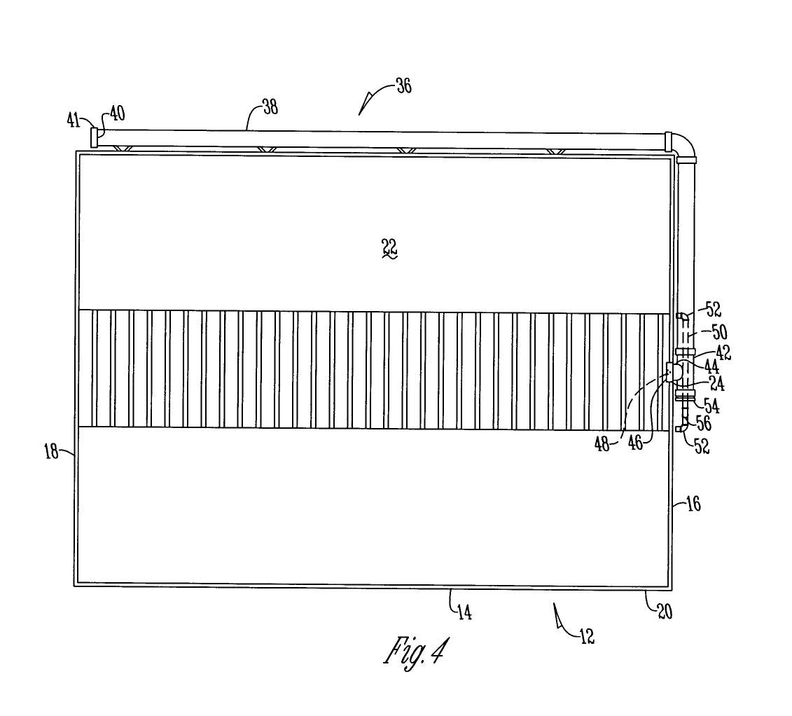

FIGS. 1 and 4 show a cleaning system 10 for a hopper 12 that includes hopper 12. Hopper 12 has a housing 14 having a front end wall 16, back end wall 18, side walls 20 extending therebetween and an open bottom to form an interior chamber 22. The hopper 12 additionally has an opening or port 24 disposed therein for access to the interior chamber 22. While the port 24 is shown within the front end wall 16 in the figures, the opening 24 could be within the back end wall 18 or within a side wall 20 without falling outside the scope of the invention.

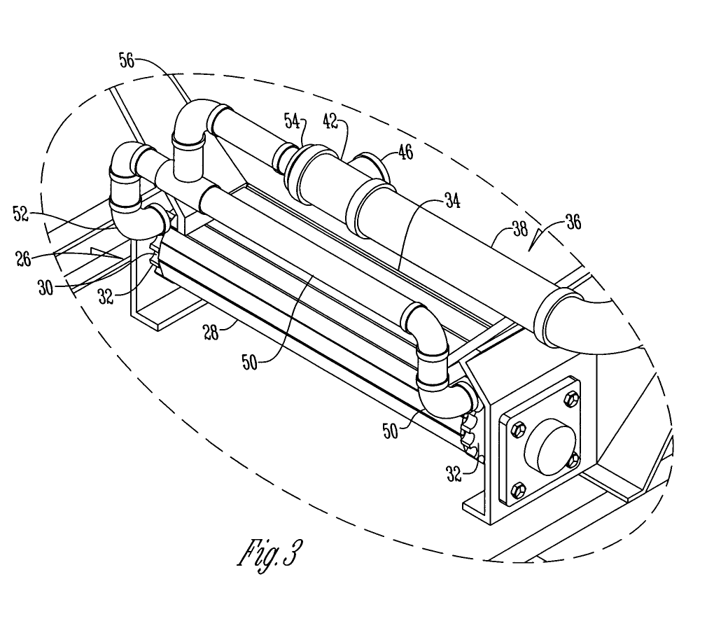

A conveyor system 26 as best shown in FIG. 3 is positioned at the open bottom of the housing 12. The conveyor system 26 has a plurality of drive wheels or gears 28 that each engage a chain 32. Each chain 32 is operably connected to a track 34 such that as the drive wheels 28 rotate the chains 32 are actuated to move the top of the track 34 axially along the open bottom of the hopper 12. Thus, any sand, salt or the like that is stored within the hopper may be conveyed from the interior 22 of the hopper toward the back end wall 18 of housing 14 using the conveyor system 26 for distribution on a road.

Mounted to the exterior of the housing 14 is a fluid supply system 36. The fluid system 36 in a preferred embodiment has a first pipe 38 having an inlet 40 that when used is connected to a hydrant (not shown). Preferably, the inlet end is formed to connect to a three-inch line having 120 psi. When not in use, the inlet end is sealed with a cap 41. Opposite the inlet end 40, the first pipe is attached to a connector 42 that is preferably T-shaped. Connected to and extending from the connector 42 is a second pipe 44 having an outlet end 46 that extends through port 24.

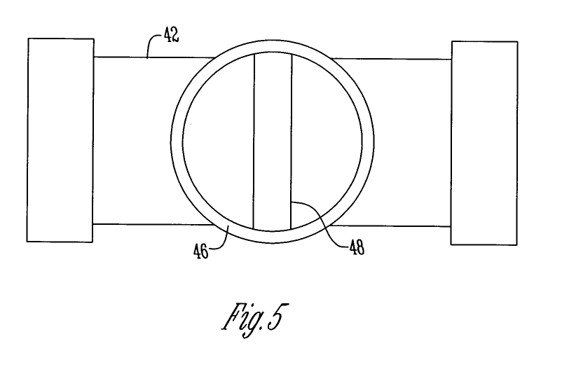

Adjacent the outlet end 46 is a spreader 48 that diverts fluid from the supply system 36 throughout the interior chamber 22 of housing 14. Preferably spreader 48 is V-shaped. Specifically the spreader 48 is secured within the connector 42 in any manner including by welding the diverter angle directly to the interior of the connector as shown in FIG. 5, by securing a plate to the interior of the connector 42 and welding the diverter angle to the plate (not shown), or the like.

Though the fluid supply system 36 may be made of any material, preferably the system is made from 316L Schedule 10 stainless steel welded pipe fittings. The stainless steel is used for its strength and ability to resist corrosion from the salt and sand. Other materials that can be used include black cast iron pipe fittings and heavy plastic fittings or the like.

Also connected to and extending from the connector 42 is a conveyor supply pipe 50 having at least one and preferably two spray nozzles 52 mounted at the outlet end. The spray nozzles 52 are positioned adjacent the conveyor system 26 and preferably are positioned adjacent the drive wheels 28.

In a preferred embodiment the conveyor supply pipe 50 is coupled to the connector 42 with a pipe coupler 54 having a plurality of chambers of varying diameters. Thus the diameter of the conveyor supply pipe 50 is less than the diameter of the inlet and outlet ends 40 and 46 to allow only a fraction of the water supplied to be diverted from the outlet end 46 to the spray nozzles 50. The pipe coupler 54 can then be connected to an elbow 56 to supply the water to the conveyor supply pipe.

Also in a preferred embodiment, the conveyor supply pipe 50 has an inverted U-shape with ¾″ pipes extending to the spray nozzles. The ¾″ pipes are angled in relation to the connector 42. By having the ¾″ pipes angled in relation to the connector 42 the pipes provide a drainage path for water within the connector 42 to prevent freezing.

By utilizing the conveyor supply pipe 50 two fluid flow paths are created wherein a first provides water to clean the interior chamber 22 of the housing while the second provides water to clean the conveyor system 26. Specifically, the first fluid flow path of water is formed from the inlet end 40 and through the outlet end 46 into the interior chamber 22 of the hopper 12. Meanwhile the second fluid flow path of water is formed from the inlet end 40 to the conveyor supply pipe 50 and onto the conveyor system 26.

In operation after a truck having the cleaning system 10 finishes depositing salt on a roadway the vehicle is parked. At this time the cap 41 is removed and a fluid source such as that of a fire hydrant is connected to the inlet end 40 to provide fluid to the system 10. The fluid then flows through the fluid supply system 36 to the outlet end 46 and to the first and second spray nozzles 52. Thus, while the spreader 48 adjacent the outlet end 46 causes water along the first fluid flow path to be spread out to clean the entire interior chamber 22 of hopper 12, the spray nozzles 52 spray clean the conveyor system 26.

Therefore, when cleaning is desired a user only needs to attach the fluid supply system 36 to a water source and activate the water source to clean both the interior 22 of the hopper 12 and the conveyor system 26. After a predetermined time the water source is deactivated and the hopper 12 is clean. Not only can this be accomplished efficiently but additionally can be accomplished safely and with minimal effort. Thus, at the very least all of the stated objectives have been met.

It will be appreciated by those skilled in the art that other various modifications could be made to the device without the parting from the spirit in scope of this invention. All such modifications and changes fall within the scope of the claims and are intended to be covered thereby.

What is claimed is:

1. A cleaning system for a hopper comprising:
a hopper having a housing enclosing an interior chamber and a port disposed within the housing for accessing the interior chamber;
a conveyor system disposed below the hopper for conveying material from the interior of the hopper;
a fluid supply system secured to the housing of the hopper, and extending from an inlet end adapted to receive water from a source to an outlet end that extends through the port of the housing to provide a first fluid flow path for water from the inlet end of the fluid supply system to the interior chamber of the housing; and
said fluid supply system having a conveyor supply pipe fluidly connected to the outlet end and having at least one nozzle adjacent the conveyor system to provide a second fluid flow path for water from the inlet end of the fluid supply system through the fluid supply system to the conveyor system.

2. The cleaning system of claim 1 further comprising a spreader adjacent the outlet end of the fluid supply system to spread water within the interior chamber of the housing of the hopper.

3. The cleaning system of claim 1 wherein the fluid supply system is of one piece construction.

4. The cleaning system of claim 1 wherein the fluid supply system comprises:
a first pipe attached to a connector;
a second pipe connected to and extending from the connector; and
said second pipe having said outlet end that extends through the port of the housing.

5. The cleaning system of claim 4 wherein the connector is a T-bar.

6. The cleaning system of claim 5 wherein the conveyor supply pipe is connected to the T-bar.

7. The cleaning system of claim 6 wherein a diverter angle is within the T-bar to divert water to the conveyor supply pipe.

8. The cleaning system of claim 1 wherein the fluid supply system extends adjacent to an exterior of the housing from the inlet end to the outlet end.

9. The cleaning system of claim 1 wherein the conveyor supply pipe comprises an inverted U-shaped conduit having first and second nozzles.

10. The cleaning system of claim 9 wherein the conveyor system comprises:
a first and second set of plurality of wheels in spaced parallel alignment;
wherein the first set of plurality of wheels engages a first chain;
wherein the second set of plurality of wheels engages a second chain; and
wherein when the first and second set of plurality of wheels rotates a track engaging the first and second chain moves axially with respect to the hopper.

11. The cleaning system of claim 10 wherein the first nozzle is adjacent the first set of plurality of wheels while the second nozzle is adjacent the second set of plurality of wheels.
